(19) United States
(12) Patent Application Publication
(10) Pub. No.: US 2024/0356688 A1
(43) Pub. Date: Oct. 24, 2024

(54) METHOD AND ARRANGEMENT FOR PERFORMING RADIO TRANSMISSIONS

(71) Applicant: KOHERENT OY, VANTAA (FI)

(72) Inventors: Kari LEPPÄNEN, Helsinki (FI); Jussi SALMI, Haarajoki (FI)

(73) Assignee: KOHERENT OY, Vantaa (FI)

(21) Appl. No.: 18/688,626

(22) PCT Filed: Sep. 27, 2022
(86) PCT No.: PCT/FI2022/050647

§ 371 Date: Mar. 1, 2024

(30) Foreign Application Priority Data
Oct. 4, 2021 (FI) 20216025

(51) Int. Cl. H04L 5/00; H04W 72/0453

(52) U.S. Cl. CPC H04L 5/0005; H04W 72/0453

(57) ABSTRACT

A method for performing radio transmissions, including assigning radio units to one subgroup of first radio units, assigning radio units to one subgroup of second radio units, assigning a signal frequency set to each subgroup of first radio units, assigning a signal frequency subset in a signal frequency set of a subgroup of first radio units to each second radio unit in a subgroup of second radio units associated with the subgroup of first radio units, wherein signal frequency subsets assigned to each second radio unit in the same subgroup of second radio units differs from each other in at least one measurement frame, transmitting, via one of the first radio units, a signal of frequencies of the assigned signal frequency set, and transmitting, via one of the second radio units, a signal of frequencies of the assigned signal frequency subset.

### TECHNICAL FIELD

The aspects of the disclosed embodiments relate to radio communication and localization in general. More specifically, the aspects of the disclosed embodiments relate to allocating transmission frequencies to groups of radio units, wherein sets of signal frequencies are allocated to first radio units and subsets of signal frequencies are allocated to associated second radio units.

### BACKGROUND

Transmissions between radio units are used for various applications. In for instance positioning applications, radio units may be used to determine distances between e.g. fixed radio nodes and mobile radio nodes that are positioned or tracked. One radio unit may transmit a signal and the phase determined at a receiving radio unit may be used to determine a distance between the transmitting and receiving radio unit.

The most accurate radio distance measurements are typically based on carrier phase techniques. In order to measure the distance directly between any two radio nodes using such techniques requires either that the radio nodes are fully phase coherent a-priori, which may be expensive to arrange especially if cables are needed, or usage of two-way transmissions. Here, a distance may be evaluated between a pair of radio units without a-priori phase synchronization, by each sending a signal having corresponding frequency that is received at the other radio unit.

Two-way transmissions also enable achieving phase-based position determination with a very low number of infra-stations (unlike in e.g. Global Navigation Satellite Systems (GNSS) where a joint phase solution over tens of links, or pairs of radio units of which at least one transmits a signal and one receives a transmitted signal, are often needed), and therefore allows phase-based positioning to be used in practical terrestrial systems.

Another example application for two-way transmission is accurate time-synchronization, which is necessary for e.g. distributed radar or cooperative beamforming communication systems.

One problem associated with two-way transmissions, however, is that it is problematic in the usage of resources and scalability. In a worst case, solutions utilizing two-way transmissions require two individual wideband transmissions for each link, which cannot be seen as scalable (e.g. in wifi 802.11af).

### SUMMARY

A purpose of the aspects of the disclosed embodiments is to alleviate at least some of the problems relating to the known prior art, especially when it comes to radio resource usage and scalability (i.e. the number or density of radio nodes that can be accurately positioned). In accordance with one aspect of the present invention, a method is provided for performing radio transmissions, the method comprising assigning at least a portion of radio units from a plurality of radio units to a group of first radio units, assigning at least one remaining radio unit from said plurality of radio units to a group of second radio units, and performing at least one measurement frame, wherein at least one performed measurement frame comprises at least
assigning each of the radio units of the group of first radio units to at least one subgroup of first radio units,
assigning each of the radio units of the group of second radio units to at least one subgroup of second radio units, wherein each subgroup of second radio units is associated with a subgroup of first radio units,
assigning a signal frequency set to each subgroup of first radio units, wherein a signal frequency set of at least one first subgroup of first radio units differs from a signal frequency set of a second subgroup of first radio units,
assigning a signal frequency subset comprised in a signal frequency set of a subgroup of first radio units to each second radio unit comprised in a subgroup of second radio units associated with the said subgroup of first radio units, wherein signal frequency subsets assigned to each second radio unit in the same subgroup of second radio units differs from each other in at least one measurement frame,
transmitting, via at least one of the first radio units, a signal comprising frequencies of the assigned signal frequency set, and
transmitting, via at least one of the second radio units, a signal comprising frequencies of the assigned signal frequency subset,
   to obtain at least one pair of radio units that has performed at least one two-way transmission.

According to other aspects, an arrangement is provided according to the independent claim 19 and a computer program product according to claim 20.

The aspects of the disclosed embodiments may provide an arrangement and method for performing radio transmissions more accurately, more directly and/or in a simpler and/or more cost-efficient way than in the prior art, while providing opportunities for two-way transmissions and related determination of phase information that may provide improved scalability.

Instead of using two individual wideband transmissions per each link or associated with each pair of radio units, in e.g. one embodiment, 8 times more tracked radio nodes/units can be accommodated with the same usage of radio resources. Even more importantly, a frequency reuse scheme becomes possible without inducing any artificial borders between areas that would lower performance locally. This allows an area without limits to be covered with an ultra accurate positioning system.

The first radio units comprised in the same subgroup of first radio units may transmit a signal consecutively in a time slot allocated to each first radio unit, and second radio units may transmit a signal in at least one time slot allocated to one or more second radio units. All second radio units comprised in the same subgroup of second radio units may in some embodiments transmit their respective signal simultaneously. The transmissions may be carried out as broadcasts.

With the method of frequency allocation according to the aspects of the disclosed embodiments, radio transmissions may be performed such that a limited number of transmissions or transmission slots are required as subgroups of first radio units may transmit their relative signals simultaneously without interference, as the simultaneously transmitted signals may differ in frequency, rather than utilizing similar frequencies and transmitting signals only consecutively.

The group of first radio units may comprise radio units that are considered essentially fixed or stationary and the group of second radio units may comprise radio units that are essentially movable or are configured to be tracked. Embodiments of the present disclosure may be utilized in tracking or positioning or determining the orientation of objects that are e.g. coupled to the second radio units. Specifically in the case of indoor positioning applications, the aspects of the disclosed embodiments may provide a cost-efficient, scalable, and/or accurate method for positioning or orientation measurement. In other embodiments the invention may be utilized for measuring and tracking the time and phase differences between the clocks/local oscillators of the radio units.

In some embodiments, two-way transmissions between at least the radio units belonging to the same pair in one of three possible pairs of radio units may be performed, wherein at least one first pair of radio units comprises two radio units in a first subgroup of first radio units, at least one second pair of radio units comprises two radio units in a second subgroup of first radio units, and at least one third pair of radio units comprises a radio unit comprised in a subgroup of first radio units and a radio unit in an associated subgroup of second radio units.

A plurality of first radio units in the same subgroup of first radio units may be configured to transmit and receive at least one signal among themselves, such that preferably all of the non-transmitting first radio units in the same subgroup receive at least one signal that is being transmitted by the other first radio units in the subgroup of first radio units, to provide a plurality of pairs of first radio units in the same subgroup that have performed two-way transmissions among themselves.

The second radio units may be configured to receive at least the signals transmitted by a plurality of and preferably all of the first radio units in an associated subgroup of first radio units and the signals transmitted by the second radio units may be received at a plurality of an preferably all of the first radio units of the associated subgroup of first radio units, such that each second radio unit forms a pair of radio units with a plurality of first radio units.

The pairs of radio units may be utilized to determine phase information regarding the phases of received signals with respect to a local oscillator of the receiving radio unit.

Two-way phase information may be used to determine phase sums and/or phase differences indicative of a sum and/or difference of phase information relating to a signal received by one of the radio units in a pair of radio units and phase information relating to a signal received by the other radio unit in the pair of radio units.

In some embodiments, distance data indicative of the distance between the radio units in a pair of radio units may be determined based on a determined phase sum or based on a combination of two-way transmissions and one-way transmissions as will be described further below.

In some embodiments, other data such as time synchronization data related to the second radio units may be determined based on a determined phase difference.

In embodiments of the present disclosure, measurement frames may be performed where e.g. distance-related data concerning the second radio units may be obtained without a requirement to perform two-way transmissions for every possible pair of radio units that may be formed within a subgroup of first radio units and an associated subgroup of second radio units. This may entail only one-way phase measurement for some pairs of radio units that may be formed within a subgroup of first radio units and an associated subgroup of second radio units in at least some of the performed measurement frames. Also, at least some measurement cycle(s) could be carried out such that second radio units only form pairs of radio units with first radio units, i.e. the radio units comprised in the subgroup(s) of second radio units do not receive signals transmitted by other second radio units (or at least are not utilized in determining phase information related to signals transmitted by other second radio units). In the present invention, distance data, position data, and/or e.g. time synchronization data related to the second radio units may be obtained without two-way transmissions between second radio units.

In one embodiment, at least one measurement frame may be carried out where two-way transmissions may be performed between at least one pair of radio units, while one-way transmissions are further performed between one or more pairs of radio units in the measurement frame. The one-way transmissions may be performed via more pairs of radio units than those participating in the two-way transmissions. One-way transmissions may be performed more frequently than the two-way transmissions.

One-way phase information may be determined based on one-way transmissions. Determined one-way phase information may be utilized to determine data indicative of one or more distances between the pairs of radio units.

In one embodiment, at least one two-way transmission may be performed to determine two-way phase information and a phase sum or phase difference therefrom. Particularly, a phase difference may be utilized to obtain clock data, wherein such data comprises information relating to time and phase differences between the local oscillators of the radio units. Additional transmissions may comprise one-way transmissions to determine one-way phase information. The one-way phase information may be used to determine distance data. Such distance data may be determined based, additionally to the one-way phase information, on the determined clock data.

It is well known that one-way phase information may be used to determine distances between radio units, but this requires that the time and phase differences between the radio units are known. With high-quality oscillators the rate of change in time/phase difference data between radio units is slower than the possible rate of change in the distance between them that is to be evaluated. The present invention may provide a scalable way of performing the needed two-way transmissions, while resources may be further saved by not performing such two-way transmissions between all radio units at every measurement frame. A method may comprise performing a plurality of measurement frames where only a portion of the measurement frames comprise two-way transmissions. Measurement frames comprising two-way transmissions may be carried out at longer, first time intervals, while measurement frames comprising one-way transmissions may be carried out at shorter, second time intervals. For instance, only every N^{th} measurement frame could comprise two-way transmissions, such as every fifth measurement frame.

A method may comprise performing at least two measurement frames, wherein at least one first subgroup of first radio units differs from a first subgroup of first radio units of a subsequent measurement frame. At least one first subgroup of second radio units may then also differ from a first subgroup of second radio units of a subsequent measurement frame. A specific second radio unit may then in a first measurement frame be assigned to a first subgroup of second radio units that is associated with a first subgroup of first radio units and in a second measurement frame the specific second radio unit may be assigned to a second subgroup of second radio units that is associated with a second subgroup of first radio units. Here, the specific second radio unit may then be involved in transmissions relating to the first and second subgroups of first radio units and thus transmissions may be carried out in relation to a plurality of directions with respect to the specific second radio unit. A position of the second radio unit may then be determined more accurately than with methods where transmissions are performed in relation to only one or less directions with respect to the second radio unit.

A plurality of measurement frames may be carried out and the assignment of first radio units to a selected configuration of subgroups of first radio units may be repeated at selected measurement frames.

The assignment of the first radio units to a subgroup of first radio units may be based on at least their mutual distance, such that first radio units assigned to the same subgroup of first radio units are within reception distance of each other.

The assignment of the second radio units to a subgroup of second radio units may be based on a determined or estimated position of the second radio units, wherein the second radio units are associated with a certain subgroup of first radio units that is closest in proximity or preferred by other properties such as positioning geometry (i.e. some first radio units in the associated subgroup of first radio units may be those closest in proximity to the second radio units, while one or more first radio units in the associated subgroup of first radio units may be ones that are not closest in proximity but give e.g. advantageous angles for transmissions, such that through the assigning of the first radio units to subgroups of first radio units into selected configurations and the assigning to different subgroups of first radio units between subsequent measurement frames, a second radio unit may be reached by the transmissions from the first radio units from at least a selected number of angles or directions). It may be considered that the assignment of second radio units to a subgroup of second radio units may be based on a determined physical space that is associated with each of the subgroups of first radio units, wherein second radio units located in or estimated to be located in a physical space allocated to a specific subgroup of first radio units are assigned to the same subgroup of second radio units or multiple physically co-located subgroups of second radio units. Such co-located subgroups are all assigned to the same subgroup of first radio units.

With embodiments of the invention and especially through the assignment of the first radio units to different configurations of subgroups of first radio units between subsequent measurement frames, obtained information regarding the second radio units through the performed transmissions may be more accurate. This is because transmissions between first radio units and second radio units may be performed from various directions having regard to the second radio units. For example, if a second radio unit is located at an edge area of a physical space that is allocated to a specific subgroup of first radio units, it may be involved in transmissions arriving/departing essentially from/to a limited angle of direction. Then, even if the second radio unit essentially does not move between measurement frames, it will be associated with a different configuration of first radio units in a consecutive measurement frame, whereby it may be involved in transmissions arriving from or departing to different angles of directions, leading to e.g. more accurate positioning data obtainable regarding the second radio unit.

A signal frequency set assigned to one subgroup of first radio units may be reused and assigned to a subsequent subgroup of first radio units in the same measurement frame if determined suitable according to frequency allocation logic. The frequency allocation logic may take into account at least distance between the radio units of the considered subgroups of first radio units, preferably a total number or subgroups of first radio units, and a signal-to-interference ratio for the distance between subgroups of first radio units. A first signal frequency set may then be reused in the same measurement frame such that simultaneous transmissions essentially do not interfere with each other. Reuse of signal frequency sets may enable the use of a limited total frequency range utilized for a given number of subgroups of first radio units. Without such reuse, the range of signal frequencies required for a given number of subgroups of first radio units would be larger and ultimately limit the number of radio units in a system.

In one embodiment, at least one measurement frame may comprise performing at least one transmission between a further pair of radio units, wherein the further pair of radio units comprises two second radio units. In this embodiment, transmissions may be utilized to determine respective phase information regarding a pair of second radio units in at least a portion of measurement frames (e.g. temporarily) if determined useful in a given use case. Here, the transmissions between second radio units may be used to directly determine distance and/or e.g. time synchronization information regarding the distance between the second radio units in the pair of second radio units. Accurate measurement of mutual geometry between two or more second radio units may be enabled by peer-to-peer measurements/transmissions even without support from first radio units (e.g. not installed in the area).

Through embodiments of the present disclosure, an arrangement and method may be easy to install and inexpensive to implement. For instance, any number of mobile second radio units may be tracked or monitored at desired time intervals and to desired precision. An arrangement according to the invention may be implemented in environments where other forms of positioning, such as satellite positioning, is not feasible, such as indoors or underground.

Problems relating to scalability may be solved or alleviated by clever usage and also re-use of narrow-band signal components as well as broadcasts in a large continuous space with a high density of nodes or radio units to be positioned.

An arrangement may be simple to operate and may be implemented essentially without use of cables, as for instance solar panels or batteries may be used for power.

In one embodiment, each of the transmitting radio units may transmit at least one signal within a predetermined time slot, further wherein the first radio unit may be a master unit and the remaining radio units are slave units. The master unit may be a radio unit that is configured to transmit the first signal in a subgroup of first radio units. The master unit may be configured to check before transmission of the first signal whether a radio channel is free for transmission and if the channel is free, the at least first signal is transmitted, said transmitting not being executed if the channel is not free.

An arrangement may advantageously utilize radio bands/channels that require listen-before-talk functionality, as a master unit may check if the radio channel is free before transmission of the first signal and if yes, then the measurement frame of the arrangement may be carried on with and the radio channel may then be reserved by the arrangement for at least the one measurement frame. If it is determined that a radio channel is not free, then the first signal may not be transmitted and the measurement frame may be aborted or cancelled without any signals being transmitted, while the master unit or first radio unit may then wait for a predetermined time between measurement frames and then at the next measurement frame, once more check if the radio band is free and then carry on with transmission of the first signal to initiate a measurement frame if the radio band is free.

In some embodiments comprising a master radio unit and one or more slave radio units, slave units may be configured to determine, before transmitting of a signal in a given measurement frame, if a previous radio unit in the predetermined order of radio units has transmitted a signal in the measurement frame, and if yes, transmit their respective signal, while the signal is not transmitted (waiting for a full measurement frame) if it is determined that the previous radio unit has not transmitted a signal, i.e., if a valid measurement signal is not received.

In embodiments of an arrangement, the at least first radio unit may send a system synchronization signal that is received by the at least remaining radio units before sending of the first signal. Through the system synchronization, the radio units may conduct transmission of signals in synchronized manner having regard to time slots associated with a predetermined order in which signals are to be transmitted, especially in embodiments where the time between subsequent measurement cycles is relatively long, such as over one minute.

In an embodiment, in one measurement frame, first radio units may transmit their assigned signals each in their own time slot, and most or at least a portion of second radio units may transmit their assigned signals simultaneously in one time slot, while a portion of second radio units transmitting in the considered measurement frame may transmit their assigned signals each in a dedicated time slot.

In one further embodiment, at least one measurement frame may comprise performing at least one further two-way transmission between a further pair of radio units, wherein at least a fourth pair of radio units comprises two second radio units, further wherein the second radio units of the further pair of radio units may transmit their respective signals consecutively, in their own time slots. Phase information indicative of phases of received signals with respect to a local oscillator the receiving radio unit may also be determined, along with a phase sum or phase difference. This may be advantageous in cases where accurate knowledge regarding e.g. a distance between at least two second radio units is desirable.

The exemplary embodiments presented in this text are not to be interpreted to pose limitations to the applicability of the appended claims. The verb “to comprise” is used in this text as an open limitation that does not exclude the existence of unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The presented considerations concerning the various embodiments of the method may be flexibly applied to the embodiments of the arrangement mutatis mutandis, and vice versa, as being appreciated by a skilled person.

### BRIEF DESCRIPTION OF THE DRAWINGS

Next the aspects of the disclosed embodiments will be described in greater detail with reference to exemplary embodiments in accordance with the accompanying drawings, in which:

FIG. 1 shows an exemplary arrangement according to one embodiment,

FIG. 2 exhibits exemplary allocation of time slots in a measurement frame and shows exemplary radio units, and subgroups of first radio units according to an exemplary arrangement according to one embodiment,

FIG. 3 shows subgroups of first radio units according to an exemplary arrangement according to one embodiment,

FIG. 4 depicts schematically an example of signal frequency sets that may be used in an embodiment,

FIG. 5 gives an allocation of signal frequencies and signal frequency subset regarding a measurement frame in one subgroup of first radio units and an associated subgroup of second radio units in relation to FIG. 4, and

FIG. 6 shows a flow chart of a method according to an exemplary embodiment.

### DETAILED DESCRIPTION

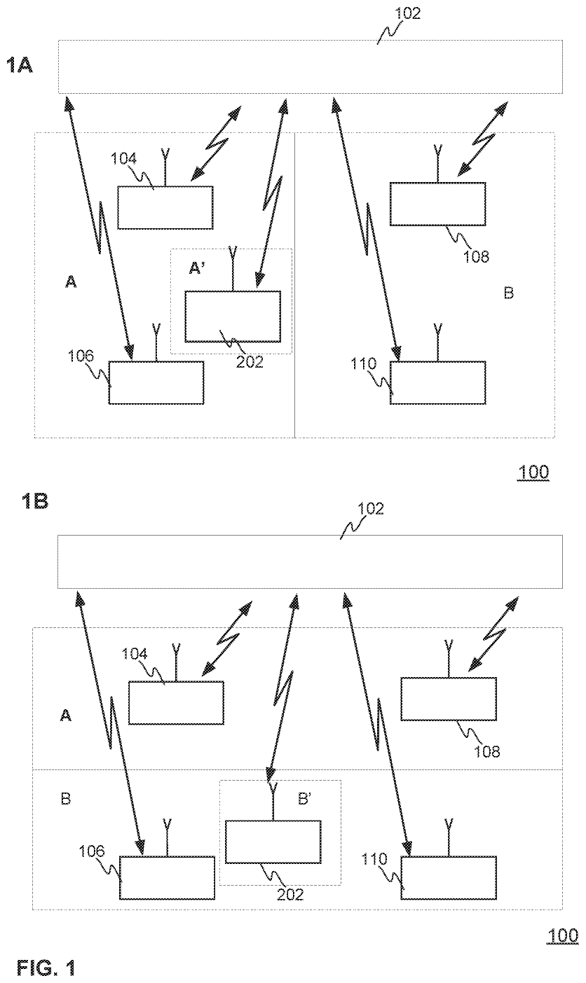

FIG. 1 shows one embodiment of an arrangement 100 according to the aspects of the disclosed embodiments. The arrangement 100 comprises at least one processor 102 and a plurality of radio units 104, 106, 108, 110, 204. Each radio unit may comprise at least one antenna unit. An antenna unit may be comprised in a radio unit or be coupled to a radio unit via e.g. cables.

The processor 102 may be a controller unit that is external to the radio units and may be implemented as a microprocessor unit or provided as a part of a larger computing unit such as a personal computer or cloud computing. In some embodiments, the processor 102 or at least a portion of it may be comprised in or be considered to be part of a radio unit 104, 106, 108, 110, 202.

The processor 102 may be configured to control the radio units 104, 106, 108, 110, 202 comprised in an arrangement 100. The processor 102 may additionally or alternatively be configured to receive data from the antenna units and/or radio units comprised in an arrangement 100 in a wired (e.g. Ethernet) or wireless (e.g. WLAN) manner.

The processor 102 and radio units 104, 106, 108, 110, 204 may be powered using for instance power-over-Ethernet (POE), direct mains supply, batteries, solar panels, or mechanical generators (e.g. in wind turbine blades).

The radio units may comprise a plurality of first radio units 104, 106, 108, 110 and at least one second radio unit 204. The first and second radio units may be similar in construction. The first radio units 104, 106, 108, 110 may be considered as essentially stationary/fixed radio units at least during one or more measurement frames that are performed via the arrangement 100. In one use case scenario, the first radio units may be fixed to a ceiling of a warehouse, for instance. The at least one second radio unit 204 may be considered a mobile radio unit that may be capable of moving between measurement frames or may e.g. be coupled to a mobile target structure or object to be positioned or located. A second radio unit may for example be coupled to an object in a warehouse that is to be tracked, such as an automated forklift.

The arrangement 100 may be configured to carry out at least one measurement frame where the processor 102 assigns first radio units 104, 106, 108, 110 to subgroups of first radio units and assigns second radio unit(s) 202 to at least one subgroup of second radio units. Each subgroup of second radio units is associated with a subgroup of first radio units.

In the example of FIG. 1, FIG. 1A depicts a situation of a first measurement frame, where a first subgroup of first radio units A comprises two radio units 104 and 106 and a second subgroup of first radio units B comprises two radio units 108 and 110. The second radio unit 202 is assigned to a first subgroup of second radio units A′ that is associated with the first subgroup of first radio units A. The dashed lines dividing the radio units into subgroups are for illustrative purposes only.

The assignment of the first radio units 104, 106, 108, 110 to subgroups of first radio units may be based on subgroup division logic that may take into account e.g. a total number or first radio units, a total number of second radio units, one or more distances between first radio units, number of measurement frames to be conducted, a total signal frequency range that is to be used for signal frequency sets, a number of subgroups of first radio units, and/or a number of signal frequency sets or subsets.

The assignment of the second radio units 202 to subgroups may be based on one or more (estimated) distances between the second radio units 202 and the first radio units 104, 106, 108, 110 or an estimated or determined position of the second radio units 202.

A subgroup of second radio units may comprise second radio units 202 that are closest in proximity to a specific subgroup of first radio units, such that second radio units 202 that are e.g. in the example of FIG. 1A closer to the first subgroup of first radio units A than the second subgroup of first radio units B are assigned to the first subgroup of second radio units A′. For example, an area or space may be allocated to each subgroup of first radio units A, B such that any second radio units 202 comprised in or expected to be comprised in said area or space are assigned to one or more subgroups of second radio units that are associated with the respective subgroup of first radio units.

At each measurement frame, the processor 102 may assign a signal frequency set to each subgroup of first radio units, wherein a first signal frequency set of the first subgroup of first radio units A differs from a second signal frequency set of the second subgroup of first radio units B, i.e. the signal frequency sets differ between at least two subgroups of first radio units, based on frequency allocation logic that will be discussed in more detail further below.

The processor 102 may also assign a signal frequency subset comprised in a signal frequency set of an associated subgroup of first radio units to each second radio unit comprised in a subgroup of second radio units, wherein signal frequency subset assigned to each second radio unit in the same subgroup of second radio units differs from another in at least one measurement frame. Thus in the example of FIG. 1A and the associated first measurement frame, a first signal frequency subset that is assigned to the second radio unit 202 is a subset of the first signal frequency set that is assigned to the first subgroup of first radio units A.

At the first measurement frame, the first radio units 104 and 106 comprised in the first subgroup of first radio units A are each configured to transmit a signal comprising frequencies of the respective assigned signal frequency set and the first radio units 108 and 110 of the second subgroup of first radio units B are configured to each transmit a signal comprising frequencies of the respective assigned signal frequency set. The second radio unit 202 is configured to transmit a signal comprising frequencies of the respective assigned signal frequency subset.

It should be noted that a measurement frame may also be carried out such that e.g. only one pair of radio units participates in the two-way transmissions, i.e. where each radio unit in the pair transmits a signal with at least one of the signal frequencies from the set or subset of assigned signal frequencies, while the other receives the signal. Other transmissions in the measurement frame may then comprise one-way transmissions between the radio unit pairs, where the used signal frequencies comprise more than one of the frequencies from the assigned set or subset of frequencies.

FIG. 1B shows the arrangement 100 at a second measurement frame, again showing the dotted lines for illustrative purposes. At the second measurement frame, the processor 102 is configured to assign the first and second radio units to subgroups of first and second radio units. At least some, preferably all, of the subgroups of first radio units differ between consecutive measurement frames. The example of FIG. 1B shows the first subgroup of first radio units A now comprising the radio units 104 and 108, i.e. a different configuration than in the first measurement frame. The second subgroup of first radio units B comprises the radio units 106 and 110.

The assignment of the second radio units 202 to the subgroups of second radio units may be based on the configurations of the subgroups of first radio units A, B. For example, an area associated with the first subgroup of first radio units A is preferably different between the first and second measurement frame. The second radio unit(s) 202 may move between measurement frames, although not necessarily.

In the example of FIG. 1B, the second radio unit 202 is in the second measurement frame assigned to a second subgroup of second radio units B′ (while in this arrangement and at this measurement frame, the first subgroup of second radio units A′ is an empty group).

In the second measurement frame, the first signal frequency set may be assigned to the first subgroup of first radio units A and the second signal frequency set may be assigned to the second subgroup of first radio units B. The second radio unit 202 may then be assigned a second signal frequency subset that is comprised in the second signal frequency set. Also other signal frequency sets and subsets may be assigned to the subgroups of radio units.

At the second measurement frame, the radio units may once more transmit their respective signals, i.e. signals with the frequencies assigned to them.

The signals may be transmitted as broadcasts, and the first radio units 104, 106, 108, 110 comprised in the same subgroup of first radio units A, B may be configured to receive the signals transmitted by at least one, a plurality, or preferably all of the other first radio units comprised in the subgroup of first radio units. First radio units may also be configured to receive signals transmitted by the second radio units 202 comprised in an associated subgroup of second radio units A′, B′.

Second radio units 202 may be configured to receive signals transmitted by first radio units 104, 106, 108, 110 comprised in an associated subgroup of first radio units A, B. Yet, second radio units may be configured to not receive signals transmitted by other second radio units comprised in the same subgroup of second radio units A′, B′ at at least a portion of measurement frames.

Via the performed transmissions, a measurement frame may result in pairs of radio units that have performed transmissions among themselves, which may be two-way transmissions, i.e. each radio unit has transmitted a signal that is received by the other radio unit in the pair of radio units. It should be noted that in at least some measurement frames, not all possible pairs of radio units may be formed, for instance if there are significant physical obstructions between some of the related radio units at a level that makes the phase measurements practically useless or impossible. It is possible that some transmissions and/or receptions by any given radio unit are omitted as controlled by the controller/processor 102. Thus, in other embodiments, only a selected first portion of the possible pairs of radio units may perform two-way transmissions, while a second selected portion (possibly at least partially overlapping with the first portion) performs one-way transmissions.

Phase information may also be determined with respect to each pair of radio units. The phase information may comprise information related to a phase of a signal at a receiving radio unit with respect to its local oscillator.

In the example of FIG. 1A at the first measurement frame, pairs of radio units may thus be formed by radio units 104 and 106, 104 and 202, 106 and 202, and 108 and 110. In the example of FIG. 1B at the second measurement frame, pairs of radio units may be formed by radio units 104 and 108, 106 and 110, 106 and 202, and 110 and 202.

The phase information may be determined by the radio units and may be sent to the processor 102. Also amplitude information may be measured and sent to the processor 102. Alternatively, the same data may be sent in complex form, comprising real and imaginary parts. Such complex data understandably carries both phase and amplitude information. The phase information may be utilized to determine distances and/or time synchronization between the radio units.

For instance, a sum of the phase information relating to a signal received at one of the radio units in a pair of radio units and the phase information related to a signal receive at the other radio unit in the pair of radio units may be used to determine distance information between the pair of radio units. For instance, patent application PCT/FI2020/050651 describes a method for monitoring of distances based on determined phase sums obtained via two-way radio transmissions.

On the other hand, the difference between the phase information obtained from the two-way transmission, i.e. a phase difference, may be used for determining other data, such as relating to accurate time synchronization.

Yet, a determined phase sum or phase difference obtained from two-way transmission(s) may be utilized in an intermediate step in a method for determining further data. E.g. other further transmissions may be carried out (for instance as one-way transmissions) and the combined obtained phase information may be used to determine further information, such as distance information.

An arrangement 100 may additionally comprise one or more position calculation units. These can be part of the processor 102 or be separate units.

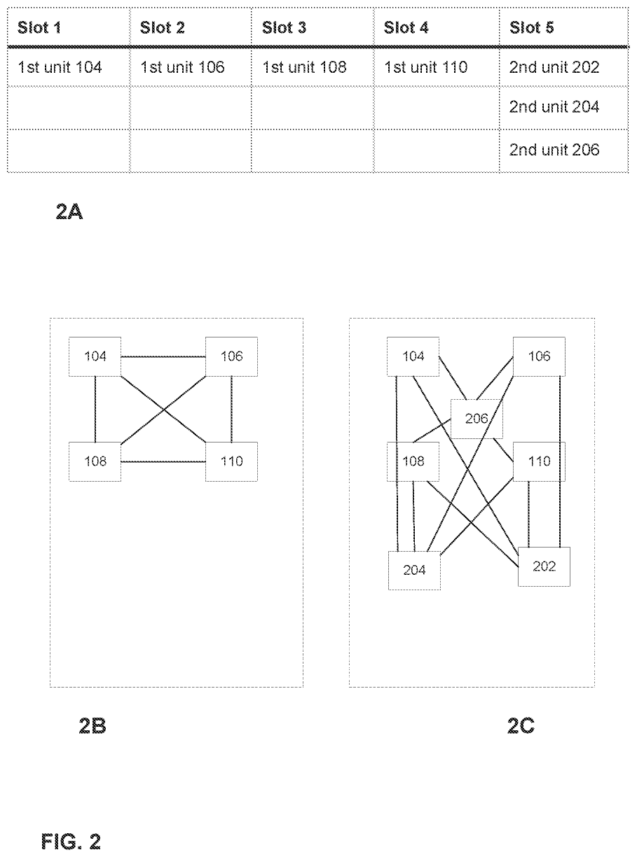

FIG. 2 depicts at 2A how time slots may be allocated in one measurement frame for transmission of signals. Times slots in the measurement frame may be allocated so that a time duration within which signals are sent one after another such that the time between subsequent transmissions is below a threshold value.

One measurement cycle may comprise at least one measurement frame (with any number of measurement slots). The measurement cycle may also comprise several measurement frames differing in the assignment of first and second radio units into subgroups. Typically the measurement cycles are repetitive. The measurement frame of the example of FIG. 2 comprises 5 measurement slots. During a measurement slot, at least one radio unit transmits its respective signal. Preferably, the first radio units in the same subgroup of first radio units each transmit a signal separately and successively in their own measurement slots using the same frequency set. The example of FIG. 2 is shown only to demonstrate allocation of time slots, and may e.g. be considered in connection with an arrangement comprising one subgroup of first radio units comprising radio units 104, 106, 108, and 110 and one subgroup of second radio units comprising radio units 202, 204, and 206. Each of the first radio units 104, 106, 108, and 110 may transmit a signal one at a time and in one measurement slot each, while the second radio units 202, 204, and 206 may all transmit their respective signals essentially simultaneously in the same time slot, using mutually exclusive frequency subsets of the frequency set which the affiliated subgroup of first radios used in their dedicated slots.

If an arrangement comprises a plurality of subgroups of first radio units A, B, the first radio units comprised in different subgroups of first radio units may transmit signals simultaneously, using their respective frequency sets, based on the frequency allocation plan. Different subgroups may have different numbers of radio units and thus time slots, but essentially the first slot in each subgroup frame may be aligned in time.

Yet, if an arrangement comprises a plurality of co-located subgroups of second radio units, the second radio units in each of the co-located subgroups of second radio units may transmit their respective signals in different slots. A plurality of co-located subgroups of second radio units assigned to the same subgroup of first radio units may be utilized for instance if the number of second radio units that would otherwise be comprised in the same subgroup of second radio units would be so large that they could not transmit their signals in the same time slot.

FIGS. 2B and 2C show the radio units that may be associated with the example of FIG. 2A and some of the two-way transmissions that may be performed during the measurement frame of FIG. 2A, after measurement slots 1-4 in FIG. 2B and after slot 5 in FIG. 2C.

The example shows a situation where a subgroup of first radio units comprises first radio units 104, 106, 108, and 110. A subgroup of second radio units associated with the subgroup of first radio units comprises second radio units 202, 204, and 206. After slots 1-4 the first radio units 104, 106, 108, and 110 of the subgroup of first radio units may have all received and sent a signal among themselves (comprising the assigned signal frequency set) and thus two-transmissions may have been carried out between radio units 104 and 106, 106 and 108, 104 and 108, 108 and 110, 106 and 110, and 104 and 110.

After measurement slot 5, the second radio units have each transmitted their respective signals of assigned signal frequency subsets which are received by all the first radio units of the subgroup of first radio units, measurement slot 5 resulting in pairs of radio units of 204 and 104, 202 and 106, 202 and 108, 202 and 110, 204 and 104, 204 and 106, 204 and 108, 204 and 110, 206 and 104, 206 and 106, 206 and 108, and 206 and 110.

In some embodiments, the second radio units may transmit signals also among themselves, at least temporarily and concerning at least two second radio units (one pair). This mode may be initiated by the processor temporarily requesting the second radio units to measure/receive also transmissions from other second radio units (in addition to receiving the transmissions from first radio units). As accurate reception is not possible during transmission without very complex full-duplex circuitry, typically such second radio units are requested to transmit in separate slots.

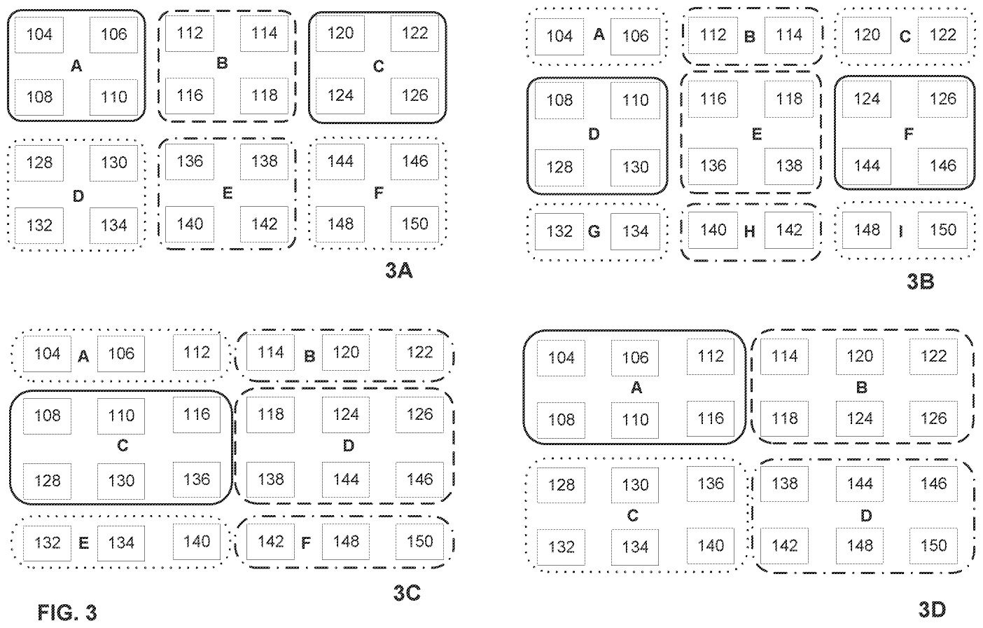

FIG. 3 shows an example of how first radio units may be assigned to subgroups of first radio units in four consecutive measurement frames. An arrangement relating to FIG. 2 comprises 24 first radio units 104, 106, 108, 110, 112, 114, 116, 118, 120, 122, 124, 126, 128, 130, 132, 134, 136, 138, 140, 142, 144, 146, 148, 150.

FIG. 3A shows an example configuration of subgroups of first radio units in a first measurement frame. A first subgroup of first radio units A comprises first radio units 104, 106, 108, and 110. A second subgroup of first radio units B comprises first radio units 112, 114, 116, and 118. A third subgroup of first radio units C comprises first radio units 120, 122, 124, and 126. A fourth subgroup of first radio units D comprises first radio units 128, 130, 132, and 134. A fifth subgroup of first radio units E comprises first radio units 136, 138, 140, and 142. A sixth subgroup of first radio units F comprises first radio units 144, 146, 148, and 150.

Signal frequency sets assigned to the subgroups of first radio units may be assigned so that the signal frequency sets differ between at least a portion of the subgroups of first radio units in one measurement frame. However, the same signal frequency set may be assigned to two or more subgroups of first radio units in the same measurement frame in some cases where deemed suitable by frequency allocation logic such that the signals transmitted by the first radio units are not interfering with each other. Suitable re-use distance for the frequency sets is such that the resulting signal-to-interference ratio is above a threshold that yields high enough phase measurement accuracy.

In the example of FIG. 3, the first subgroup of first radio units A and the third subgroup of first radio units C have both been assigned with a first signal frequency set, which is demonstrated through the figure by encircling the first radio units in said subgroups with a solid trace. The second subgroup of first radio units B has been assigned with a second signal frequency set, which is demonstrated in FIG. 3 with a dashed line. The fourth subgroup of first radio units D and sixth subgroup of first radio units F have been assigned with a third signal frequency set, demonstrated through a dotted line. Finally, the fifth subgroup of first radio units E has been assigned with a fourth signal frequency set, demonstrated via a dotted-dashed line.

In order to reuse the signal frequency set for two subgroups of first radio units, say A and C, the minimum signal-to-interference ratio obtained in such an arrangement, SIRₘᵢₙ^{AC}, should be larger than a minimum acceptable threshold value for the signal-to-interference ratio SIRₜₕ. The threshold value may be obtained e.g. through

$${SIR}_{th} = \frac{1}{{Δφ}^{2}} , \qquad ( 1 )$$

where Δφ is the maximum acceptable phase error allowed for the determined phase information in radians. The value of Δφ may depend on a desired accuracy for the end result, such as a desired accuracy for an evaluated distance or determined clock data. The equation is approximate and holds for small values of Δφ(<π/10).

The minimum achievable signal-to-interference ratio may be determined by propagation simulation, ray tracing, determination of the ratio by performing transmissions with the radio units, or by utilizing a measured or estimated minimum distance between any member in one subgroup of first radio units and any member in another subgroup of first radio units and the measured or estimated maximum distance of members within these subgroups of first radio units and wherein:

$$\begin{matrix}{SIR}_{min}^{A C} = ( \frac{{d}_{min}^{A C}}{{d}_{max}^{A A}} ) & {}^{γ} \geq {SIR}_{th}\end{matrix} \qquad ( 2 )$$

where dₘᵢₙ^{AC}, is the minimum distance between any member in subgroup A of first radio units and any member in subgroup C of first radio units (minimum inter-group distance), dₘₐₓ^{AA} is the maximum distance of members within the subgroup A (or subgroup C, maximum intra-group distance), and γ is the power exponent of the propagation law, i.e. the exponent of power decay over distance. If there is only line-of-sight everywhere, this exponent is 2 (signal power is inversely proportional to the distance squared). If there are significant physical obstacles, it can even be 4.

FIG. 3B shows an example of how the configuration of subgroups of first radio units may be altered in a second measurement frame. In the second measurement frame, the members of the subgroups of first radio units may be changed at least partially and additionally, the signal frequency sets allocated may be changed.

A first subgroup of first radio units A comprises first radio units 104 and 106. A second subgroup of first radio units B comprises first radio units 112 and 114. A third subgroup of first radio units C comprises first radio units 120 and 122. A fourth subgroup of first radio units D comprises first radio units 108, 110, 128, and 130. A fifth subgroup of first radio units E comprises first radio units 116, 118, 136, and 138. A sixth subgroup of first radio units F comprises first radio units 124, 126, 144, and 146. A seventh subgroup of first radio units G comprises first radio units 132 and 134. An eighth subgroup of first radio units H comprises first radio units 140 and 142. A ninth subgroup of first radio units I comprises first radio units 148 and 150

A subgroup of first radio units may comprise a number of first radio units that may efficiently participate in locating a second radio unit, such as e.g. 4-6 first radio units. A subgroup of first radio units could, however, comprise e.g. 2-15 first radio units. The number of subgroups of first radio units in an arrangement and the number of first radio units in any given subgroup may vary between measurement frames. In some embodiments, subgroups of first radio units located at an edge of a perimeter formed by the first radio units could always comprise four or more first radio units.

The subgroups of first radio units may be considered as forming cells comprising a physical shape that may be described by an outer perimeter defined by the radio units of the subgroup of first radio units. For instance, in FIG. 3A, the subgroups of radio units may be considered as forming cells with rectangular shape. Depending on the embodiment, the cells may comprise also different shape, such as hexagonal. An interlaced grid may also be utilized in some embodiments, such that first radio units in the same subgroup of first radio units may be comprised in rows and columns, where a column is e.g. at a 45 degree angle with respect to a row.

In the example of FIG. 3 and the situation of the second measurement frame depicted in FIG. 3B, the first subgroup of first radio units A, the third subgroup of first radio units C, seventh subgroup of first radio units G, and the ninth subgroup of first radio units I have been assigned with the third signal frequency set (dotted line). The second subgroup of first radio units B and the eighth subgroup of first radio units H have been assigned with the fourth signal frequency set (dotted-dashed line). The fourth subgroup of first radio units D and the sixth subgroup of first radio units F have been assigned with the first signal frequency set (solid line), while the fifth subgroup of first radio units E has been assigned with the second signal frequency set (dashed line).

FIG. 3C shows an example configuration of subgroups of first radio units and assigned signal frequency sets of a third measurement frame. A first subgroup of first radio units A comprises first radio units 104, 106, and 112 and has been assigned with the third signal frequency set (dotted line). A second subgroup of first radio units B comprises radio units 114, 120, and 122 and has been assigned with the fourth signal frequency set (dotted-dashed line). A third subgroup of first radio units C comprises first radio units 108, 110, 116, 128, 130, and 136 and has been assigned with the first signal frequency set (solid line). A fourth subgroup of first radio units D comprises first radio units 118, 124, 126, 138, 144, and 146 and has been assigned with the second signal frequency set (dashed line). A fifth subgroup of first radio units E comprises first radio units 132, 134, and 140 and has been assigned with the third signal frequency set (dotted line). A sixth subgroup of first radio units F comprises first radio units 142, 148, and 150 and has been assigned with the fourth signal frequency set (dotted-dashed line).

FIG. 3D shows an example configuration of subgroups of first radio units and assigned signal frequency sets of a fourth measurement frame. A first subgroup of first radio units A comprises first radio units 104, 106, 112, 108, 110, and 116 and has been assigned with the first signal frequency set (solid line). A second subgroup of first radio units B comprises radio units 114, 120, 122, 118, 124, and 126 and has been assigned with the second signal frequency set (dashed line). A third subgroup of first radio units C comprises first radio units 128, 130, 136, 132, 134, and 140 and has been assigned with the third signal frequency set (dotted line). A fourth subgroup of first radio units D comprises first radio units 138, 144, 146, 142, 148, and 150 and has been assigned with the fourth signal frequency set (dotted-dashed line).

FIG. 3E depicts an example configuration of subgroups of first radio units and assigned signal frequency sets of a fifth measurement frame. Here, the first radio units 104, 112, 120, 128, 136, and 144 have been assigned to a first subgroup of first radio units A, which has been assigned with the first signal frequency set. First radio units 106, 114, 122, 130, 138, and 146 have been assigned to a second subgroup of first radio units B, which has been assigned with the second signal frequency set. First radio units 108, 116, 124, 132, 140, and 148 have been assigned to a third subgroup of first radio units C, which has been assigned with the third signal frequency set. First radio units 110, 118, 126, 134, 142, and 150 have been assigned to a fourth subgroup of first radio units D, which has been assigned with the fourth signal frequency set. As seen from FIG. 3E, the first radio units assigned to the same subgroup of first radio units are not necessarily first radio units that are located adjacent to each other, as was the case in FIGS. 3A-3D.

The different configurations of subgroups of first radio units may be recycled. For instance, in connection with the example of FIG. 3, a sixth or eleventh measurement frame may again comprise the situation of FIG. 3A. The recycling of a certain configuration of first subgroups of first radio units may thus be carried out e.g. at every fourth measurement frame such that a total of four different configurations of subgroups of first radio units are employed. Also any other number of different configurations of subgroups of first radio units may be used, while four may be advantageous in the case of a rectangular grid as the four quadrants may be covered. In the case of a hexagonal arrangement, three or six different configurations of subgroups of first radio units may for instance be used (and reused/recycled at every third or sixth measurement frame).

The assignment of the first radio units to subgroups of first radio units and/or the selection of different configurations of subgroups of first radio units in different measurement frames may be based on one or more transmission characteristics regarding the associated subgroup(s) of second radio units. The transmission characteristics may comprise characteristics relating to a numbers of first radio units that are desired to be involved in transmissions in a single frame, on one hand, and a complete measurement cycle comprising a selected number of measurement frames, on the other, and relating to a selected determined physical space that is associated with the subgroups of related first radio units.

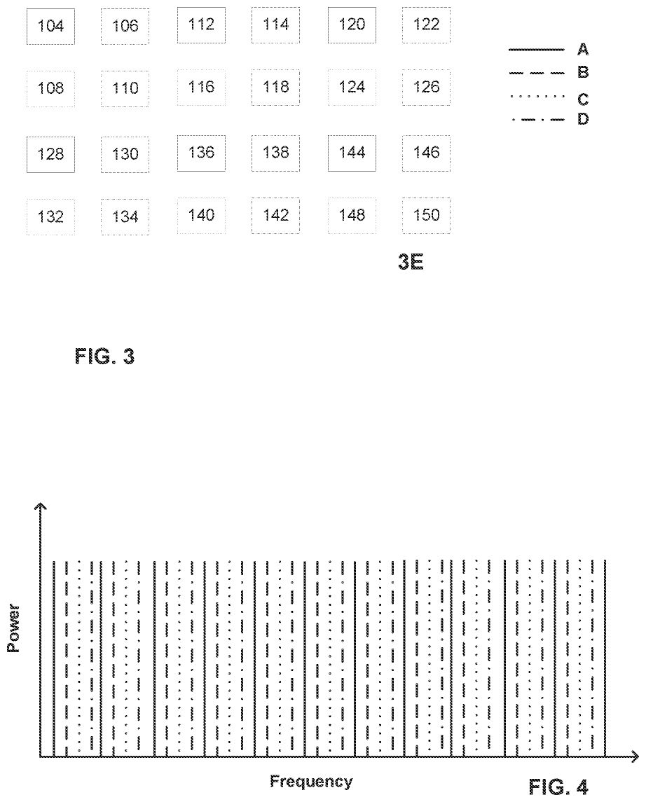

FIG. 4 shows an example of signal frequency sets that may be used e.g. in connection with the subgroups of first radio units of FIG. 3. Frequency allocation logic may determine how frequencies of a given total frequency range are divided into signal frequency sets and how these are assigned to the subsets of first radio units. In the example of FIG. 4, four signal frequency sets are used and a total frequency range is divided into said signal frequency sets such that at least a portion of adjacent or subsequent frequencies in the total range belong to a different signal frequency set, to provide the different signal frequency sets at interleaved frequencies. In FIG. 4, a first signal frequency set is depicted using a solid line, a second signal frequency set is shown with a dashed line, a third signal frequency set with a dotted line, and a fourth signal frequency set with a dotted-dashed line.

In other embodiments, signal frequency sets may comprise frequencies in continuous, non-overlapping frequency ranges that are repeated at selected intervals. Advantageously, the signal frequency sets span frequency ranges such that the total frequency range is as wide as possible.

The number of signal frequency sets utilized may depend on a total range of frequencies that is utilized, the required frequency re-use distance, and/or a total number of first and/or second radio units.

In one example, there may be 512 signal frequencies over a total bandwidth of 40 MHz. A total bandwidth may be e.g. N times the channel raster in wifi channels (20 MHZ). A value of 40 MHz may be advantageous as higher value may take too much radio resources and may be difficult to fit between wifi channels, while a lower bandwidth may compromise position measurement accuracy. For efficient implementation it is advantageous to use digital techniques and Fast Fourier Transform in the receiver. Hence the exemplary value of 512 for the number of signal frequencies. Here, a spacing of signal frequencies of 78125 Hz may be utilized. The signal frequency spacing is advantageously near this number, as with much smaller spacing neighboring signal frequencies may interfere with each other, because an actual reception frequency can vary a few thousand Hz because of Doppler and oscillator frequency errors. The spacing could be higher, but this would consume more bandwidth and also make the system less suitable for larger distance measurement ranges. A spacing of signal frequencies could be between e.g. 25000 Hz and 250000 Hz.

In the above example, 16 signal frequency sets may be used, each with 32 signal frequencies. The example depicted in FIG. 4 is merely exemplary, but shows 4 signal frequency sets each with 12 signal frequencies.

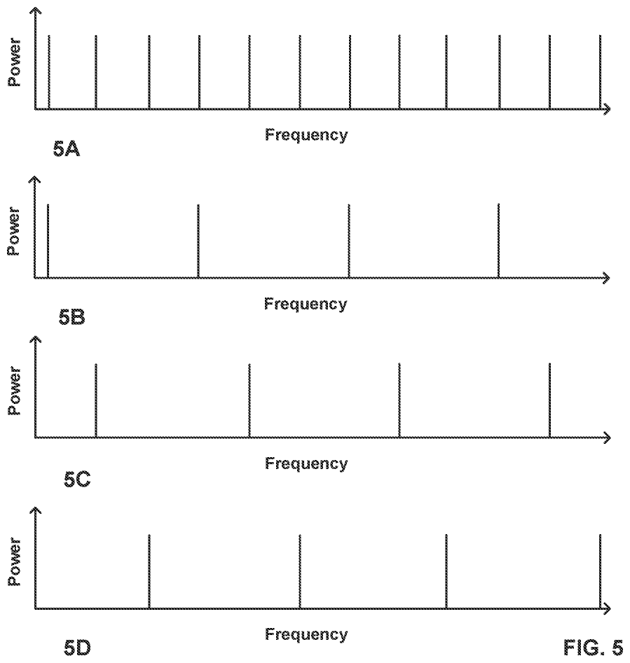

FIG. 5 gives an allocation of signal frequencies and signal frequency subset regarding a measurement frame in one subgroup of first radio units and one associated subgroup of second radio units. The situation of FIG. 5 could, for instance, be utilized in the case shown in FIGS. 2B and 2C where a subgroup of first radio units is associated with a subgroup of second radio units having three second radio units. Of course, also some other configuration of e.g. subgroup of first radio units could be considered in connection with FIG. 5.

FIG. 5A shows a first signal frequency set that corresponds to the first signal frequency set of FIG. 4. For instance in a first measurement frame, at least one or a portion of the first radio units comprised in the same subgroup of first radio units to which the first signal frequency set is allocated may transmit signals with these frequencies, each in their own measurement slots (as depicted e.g. in FIG. 2A).

FIGS. 5B, 5C, and 5D show signal frequency subsets that may be assigned to second radio units in a subgroup of second radio units associated with the first subgroup of radio units that is associated with the subgroup of first radio units that has been assigned with the first signal frequency set as depicted in FIG. 5A. For instance in connection with a case as seen in FIG. 2C, the second radio unit 202 may be assigned a signal frequency subset as seen in FIG. 5A, the second radio unit 204 may be assigned a signal frequency subset as seen in FIG. 5B, and the second radio unit 206 may be assigned a signal frequency subset as seen in FIG. 5C. Thus each second radio unit comprised in the same subgroup of second radio units is assigned a different signal frequency subset (where the signal frequency subsets are all comprised in the same signal frequency set that is assigned to the associated subgroup of first radio units). The second radio units comprised in the same subgroup of second radio units may transmit their respective signals in the same measurement slot simultaneously, as depicted in FIG. 2A.

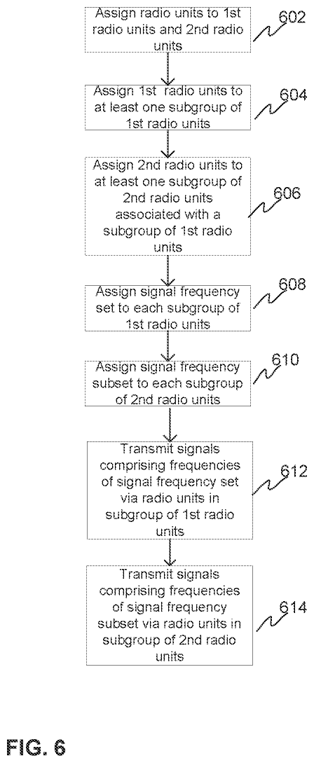

FIG. 6 shows a flow chart of a method for performing radio transmissions according to one embodiment of the invention. The method may comprise assigning 602 at least a portion of radio units from a plurality of radio units to a group of first radio units, and least one remaining radio unit from said plurality of radio units to at least one group of second radio units.

In a at least one performed measurement frame, each of the radio units of the group of first radio units may be assigned 604 to at least one subgroup of first radio units, and each of the radio units of the group of second radio units may be assigned 606 to at least one subgroup of second radio units, wherein each subgroup of second radio units is associated with a subgroup of first radio units.

A signal frequency set may be assigned at 608 to each subgroup of first radio units, wherein a signal frequency set of at least one first subgroup of first radio units differs from a signal frequency set of a second subgroup of first radio units.

A signal frequency subset comprised in a signal frequency set of a subgroup of first radio units may be assigned at 610 to each second radio unit comprised in a subgroup of second radio units associated with the said subgroup of first radio units, wherein signal frequency subsets assigned to each second radio unit in the same subgroup of second radio units differs from each other in at least one measurement frame.

Transmissions may be performed at 612, via at least one of the first radio units, comprising transmitting a signal comprising frequencies of the assigned signal frequency set. At least one of the second radio units may then transmit 614 a signal comprising frequencies of the assigned signal frequency subset.

1. A method for performing radio transmissions, the method comprising assigning at least a portion of radio units from a plurality of radio units to a group of first radio units, assigning at least one remaining radio unit from said plurality of radio units to at least one group of second radio units, and performing at least one measurement frame, wherein at least one performed measurement frame comprises at least
assigning each of the radio units of the group of first radio units to at least one subgroup of first radio units,
assigning each of the radio units of the group of second radio units to at least one subgroup of second radio units, wherein each subgroup of second radio units is associated with a subgroup of first radio units,
assigning a signal frequency set to each subgroup of first radio units, wherein a signal frequency set of at least one first subgroup of first radio units differs from a signal frequency set of a second subgroup of first radio units,
assigning a signal frequency subset comprised in a signal frequency set of a subgroup of first radio units to each second radio unit comprised in a subgroup of second radio units associated with the said subgroup of first radio units, wherein signal frequency subsets assigned to each second radio unit in the same subgroup of second radio units differs from each other in at least one measurement frame,
transmitting, via at least one of the first radio units, a signal comprising frequencies of the assigned signal frequency set, and
transmitting, via at least one of the second radio units, a signal comprising frequencies of the assigned signal frequency subset.

2. The method of claim 1, wherein the at least one performed measurement frame comprises
transmitting, via at least one of the first radio units, a further signal comprising frequencies of the assigned signal frequency set, and/or
transmitting, via at least one of the second radio units, a further signal comprising frequencies of the assigned signal frequency subset.

3. The method of claim 1, wherein the method comprises performing a plurality of measurement frames, wherein a portion of the measurement frames comprises transmitting signals via only at least one of the first radio units or via only at least one of the second radio units.

4. The method of claim 1, wherein the method comprises performing at least two measurement frames, wherein at least one first subgroup of first radio units differs from a first subgroup of first radio units of a subsequent measurement frame, wherein the method preferably comprises performing a plurality of measurement frames and the assignment of first radio units to a selected configuration of subgroups of first radio units is repeated at selected measurement frames.

5. The method of claim 1, wherein the group of first radio units comprises radio units that are considered essentially fixed and the group of second radio units comprises radio units that are essentially movable or configured to be tracked.

6. The method of claim 1, wherein the assignment of the first radio units to a subgroup of first radio units is based on at least their mutual distance, such that first radio units assigned to the same subgroup of first radio units are within reception distance of each other.

7. The method of claim 1, wherein the assignment of the second radio units to a subgroup of second radio units is based on a determined or estimated position of the second radio units, wherein the second radio units are associated with a certain subgroup of first radio units that is closest in proximity.

8. The method of claim 1, wherein the assignment of signal frequency sets is based on frequency allocation logic dividing a total signal frequency range into one or more signal frequency sets, preferably wherein at least a portion of adjacent or subsequent frequencies in the total range belong to a different signal frequency set to provide the different signal frequency sets at interleaved frequencies, or wherein signal frequency sets comprise frequencies in continuous, non-overlapping frequency ranges.

9. The method of claim 1, wherein a first signal frequency set assigned to a first subgroup of first radio units is reused and assigned to a subsequent subgroup of first radio units in the same measurement frame if determined suitable according to frequency allocation logic, said frequency allocation logic taking into account at least distance between the radio units of the first and subsequent subgroups of first radio units.

10. The method of claim 9, wherein the frequency allocation logic takes into account a signal-to-interference ratio for the distance between subgroups of first radio units where a signal frequency set may be reused, by determining the minimum achievable signal-to-interference ratio and determining that said minimum achievable signal-to-interference ratio is larger than a threshold value for a considered distance between one subgroup of first radio units and one other subgroup of first radio units, and reusing a signal frequency set by assigning the same signal frequency set to both of the considered subgroups of first radio units.

11. The method of claim 10, wherein the minimum achievable signal-to-interference ratio is determined by propagation simulation, determination of the ratio by performing transmissions with the radio units, ray tracing, or as a ratio of minimum distance between any member in one subgroup of first radio units and any member in another subgroup of first radio units and the maximum distance of members within these subgroups of first radio units, and raising this ratio to the power exponent of the propagation law.

12. The method of claim 1, wherein the first radio units comprised in the same subgroup of first radio units transmit a signal consecutively in a time slot allocated to each first radio unit, and/or second radio units transmit a signal in at least one time slot allocated to one or more second radio units, optionally wherein all second radio units in the same subgroup of second radio units transmit their respective signal simultaneously.

13. The method of claim 1, wherein the method additionally comprises performing transmissions between at least three pairs of radio units, wherein at least one first pair of radio units comprises two radio units comprised in a first subgroup of first radio units, at least one second pair of radio units comprises two radio units comprised in a second subgroup of first radio units, and at least one third pair of radio units comprises a radio unit comprised in a subgroup of first radio units and a radio unit comprised in an associated subgroup of second radio units.

14. The method of claim 1, wherein the method additionally comprises receiving a signal transmitted from one radio unit at another radio unit to obtain a pair of radio units, and for at least one pair of radio units, determining phase information indicative of phases of received signals with respect to a local oscillator the receiving radio unit.

15. The method of claim 14, additionally comprising determining at least one phase sum and/or phase difference indicative of a sum or difference of phase information relating to a signal received by one of the radio units in a pair of radio units and phase information relating to a signal received by the other radio unit in the pair of radio units, wherein said pair of radio units has performed at least one round of two-way transmissions.

16. The method of claim 15, wherein the method comprises determining clock data indicative of a time and/or phase difference between local oscillators of the radio units in the pair of radio units based on a determined phase difference.

17. The method of claim 14, wherein the method comprises determining data indicative of distances between a plurality of radio units.

18. The method of claim 1, wherein at least one measurement frame comprises performing at least one further transmission between a further pair of radio units, wherein a further pair of radio units comprises two second radio units, further wherein the second radio units of the further pair of radio units preferably transmit their respective signals consecutively, in their own time slots.

19. An arrangement for performing transmissions, the arrangement comprising at least a group of first radio units comprising a plurality of radio units, at least one group of second radio units comprising at least one radio unit, and at least one processor, wherein the processor is configured to initiate and execute at least one measurement frame, where in at least one performed measurement frame the arrangement is configured to at least
assign each of the radio units of the group of first radio units to at least one subgroup of first radio units,
assign each of the radio units of the group of second radio units to at least one subgroup of second radio units, wherein each subgroup of second radio units is associated with a subgroup of first radio units,
assign a signal frequency set to each subgroup of first radio units, wherein a signal frequency set of at least one first subgroup of first radio units differs from a signal frequency set of a second subgroup of first radio units,
assign a signal frequency subset comprised in a signal frequency set of an associated subgroup of first radio units to each second radio unit comprised in a subgroup of second radio units, wherein signal frequency subsets assigned to each second radio unit in the same subgroup of second radio units differs from each other in at least one measurement frame,
wherein first radio units comprised in the same subgroup of first radio units are configured to transmit a signal comprising frequencies of the assigned signal frequency set, and second radio units comprised in an associated subgroup of second radio units are configured to transmit a signal comprising the frequencies of the assigned signal frequency subset.

20. A computer program product comprising code means stored on a non-transient storage medium configured, when run on a processor, to cause the processor to initiate execution of the method of claim 1.

21. A non-transitory carrier medium comprising the computer program product of claim 20.
